(19) United States
(12) Patent Application Publication
(10) Pub. No.: US 2022/0383433 A1
(43) Pub. Date: Dec. 1, 2022

(54) DYNAMIC TASTE PALATE PROFILES

(71) Applicant: AT&T Intellectual Property I, L.P., Atlanta, GA (US)

(72) Inventors: Robert T. Moton, JR., Alpharetta, GA (US); Adrianne Binh Luu, Atlanta, GA (US); James Pratt, Round Rock, TX (US); Barrett Kreiner, Woodstock, GA (US); Walter Cooper Chastain, Atlanta, GA (US); Ari Craine, Marietta, GA (US); Robert Koch, Peachtree Corners, GA (US)

(21) Appl. No.: 17/330,757

(22) Filed: May 26, 2021

(51) Int. Cl. G06Q 50/12; G06Q 30/06

(52) U.S. Cl. CPC G06Q 50/12; G06Q 30/0631; G06Q 30/0641; G06Q 30/0633

(57) ABSTRACT

A processing system including at least one processor may obtain a taste palate profile of a user, wherein the taste palate profile of the user comprises rankings for a plurality of aspects of taste, identify at least one menu item matching the taste palate profile of the user, and provide a menu for the user, where the menu includes an indicator of the at least one menu item matching the taste palate profile of the user.

The present disclosure relates generally to interactive dining systems and more particularly to methods, computer-readable media, and apparatuses for providing a menu for a user including an indicator of at least one menu item matching a taste palate profile of the user.

### BACKGROUND

Current restaurant technologies may include inventory management systems, ordering systems, and point-of-sale devices. For instance, some restaurants may track which dishes are most ordered, and may adjust menus in response to the most popular dishes. In addition, some restaurants may keep track of repeat patrons and the dishes that they order (e.g., in a customer database), so as to allow wait-staff to recommend and remind patrons of the dishes that they have previously enjoyed. Moreover, table-side or table-top electronic devices have been introduced in some restaurants via which diners can view menus, place orders, and pay for services.

### SUMMARY

In one example, the present disclosure describes a method, non-transitory computer-readable medium, and apparatus for providing a menu for a user including an indicator of at least one menu item matching a taste palate profile of the user. For instance, in one example, a processing system including at least one processor may obtain a taste palate profile of a user, wherein the taste palate profile of the user comprises rankings for a plurality of aspects of taste, identify at least one menu item matching the taste palate profile of the user, and provide a menu for the user, where the menu includes an indicator of the at least one menu item matching the taste palate profile of the user.

### BRIEF DESCRIPTION OF THE DRAWINGS

The teachings of the present disclosure can be readily understood by considering the following detailed description in conjunction with the accompanying drawings, in which:

FIG. 1 illustrates an example system comprising one or more communication networks related to the present disclosure;

FIG. 2 illustrates an example user taste palate profile and an example menu item flavor profile, in accordance with the present disclosure;

FIG. 3 illustrates an example electronic menu generated in accordance with a user taste palate profile, according to the present disclosure;

FIG. 4 illustrates a flowchart of an example method for providing a menu for a user including an indicator of at least one menu item matching a taste palate profile of the user; and

FIG. 5 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure maintain user taste palate profiles and facilitate dynamic electronic menus tailored to the user's taste palate profiles. For instance, a diner may be equipped with an electronic device such as a smartphone, smartwatch, smart eyeglasses or other user devices (broadly a user device). The user device may include an application (app) for restaurant dining. The app may be for a specific restaurant or it may be functional across a number of different restaurants. The user device may have location awareness and networking connectivity, such as near-field communication, Wi-Fi, and/or cellular data-based communication capabilities, and so forth. When the diner, or user, nears or enters the restaurant, a notification may be sent to a network-based processing system (e.g., an application server(s)) notifying the restaurant. Optionally, the restaurant may offer this service to the diner in advance of a visit, allowing the user to make meal selections in advance (e.g., in such case a processing system/network-based server(s) may be operated by or otherwise associated with the restaurant). In one example, the app may communicate a unique diner ID to the network-based server. The network-based server may use the diner ID to locate data in a diner profile for the user in a diner database. The data may include a taste palate profile/preferences for the user. For instance, in one example, the taste palate preferences may comprise rankings of the user for at least five aspects of taste (e.g., bitter, salty, sour, sweet, umami, and in one example may additionally include cold and hot in terms of perception of coolness and hotness e.g., menthol and spiciness of the dishes). The taste palate profile may be stored in any number of ways that quantify the rankings with respect to the aspects of taste. For instance, one example may implement a 1-100 palate score for the user for each type, or aspect of taste. In one example, the rankings may be entered by the user via a user interface of the app. Alternatively or in addition, the rankings may be calculated by the processing system over time, based upon restaurant ordering events of the user, e.g., analyzing ingredients of prior dishes ordered by the user. In addition, the diner profile may include dietary restrictions, such as food allergies or other dietary needs, religious or other self-selected restrictions. These additional data points may be part of the user taste palate profile or may be maintained separately in the diner profile.

In accordance with the present disclosure, a restaurant may maintain a menu supply database. Such database may contain a listing of all ingredients available on-site and may be used to calculate the number of portions of each menu item that is available to be prepared. For each available menu item, the menu supply database may also include data describing any allergens in the dish, dietary compliance, and a flavor profile—which may be entered manually or may be calculated based on individual flavor profiles of ingredients and the recipe used. For instance, each ingredient in the database may include metadata describing data such as: origin date (such as harvest date), source (such as name of farm), location of the source, best-by or expiration date, flavor profile, and so forth. For menu items or ingredients, the flavor profile may include metrics (e.g., scores or values) for the at least five aspects of taste associated with the at least one menu item. For instance, the metrics for each aspect of taste may be based on a scale of 1-100 or the like, where the flavor profile may characterize the different aspects of taste which are present in the menu item or ingredient (e.g., according to the perception of one or more users providing ratings/scores the menu item or ingredient, such as kitchen staff, other restaurant staff, food critics, etc., or according to one or more automated systems that may detect olfactory components and/or chemical compositions of the food items or ingredients, and which may quantify the menu items or ingredients on the different aspects of taste presenting in the food items or ingredients).

The processing system may use all of the available data regarding a user's taste palate preferences and menu item flavor profiles to dynamically make decisions about a customized menu to present to the user (e.g., a patron/diner). The menu may be presented on the user device or on another display, such a table display provided by the restaurant. For example, the processing system may compare the user's taste palate profile/preferences with the flavor profile for menu items/dishes for which portions can be made based on available ingredients. Menu items that may be more likely to appeal to the user (e.g., those that are the best matches/have the highest matching scores) may be provided with indicators in the menu that is presented to the user, such as being ordered or placed at the top of a list on the menu, providing the matching scores next to the menu items, highlighting the menu items, providing a text note that the menu item(s) is/are being recommended based on matching the user's taste palate profile, etc. In the same manner, the menu may be generated, or personalized to contain an indication of past menu items that the user has ordered and/or consumed, including whether the user liked the menu items based on one or more records of the user's ordering history.

Similarly, the processing system may use the ingredient metadata to present additional dynamic information about the menu items/dishes presented on the menu. For instance, the user may click to receive additional information, such as information about the source of the ingredient (e.g., the farmer, the fisherman, etc.). Based on the availability and/or the freshness of ingredients, the restaurant may present dynamic pricing. For example, if there is a large supply of organic eggplant that would likely spoil unless sales of eggplant based dishes, e.g., eggplant parmesan increase, the restaurant may decrease the price (e.g., via restaurant personnel utilizing a user interface), or the restaurant may set-up supply thresholds so that dynamic pricing is adjusted automatically. The processing system may cross-reference the diner database to ensure that if there is more than one diner in a party at the restaurant, all party members are presented with the same price for the same items.

In one example, based on the presentation of menu options, the user may make one or more selections via a menu UI. Following the meal, the user may optionally provide feedback on how well the user liked the menu item(s) selected. This data may be used to populate a diner history, which may be stored in the diner profile of the diner database and/or on the user device. It may then be used to help with future menu selections, as noted. For instance, the user may provide feedback via a UI, such that a dish was “too salty.” The feedback may also be presented to the restaurant.

The choices made by the user and the feedback score(s) for the menu items may also be used to adjust the user's taste palate profile/preferences. For instance, if the user tends to choose menu items with a higher sweet score/ranking and/or gives positive feedback for such menu items, the user's tastes palate profile may be adjusted to increase the ranking for “sweet.” The user's feedback may also be used to provide feedback scores to the restaurant on how pleased their diners are, collectively, with a specific chef, the source of one or more ingredients, and so forth. This data may be used, for instance, to identify which chef gets the highest ratings for preparation of a specific dish/menu item on the menu. Likewise, if dishes/menu items that include ingredients from different sources, the restaurant may wish to purchase the ingredients from sources with consistently higher scores.

When making selections, the user may choose a meal comprised of one or more menu items, and may also make an indication via the UI of other menu items that looked appealing (e.g., second choice menu items). By indicating other appealing choices, the processing system may collect additional data to better form the user's taste palate profile. These “second choices” may be stored as menu items that have not yet been tasted. For instance, the next time the user visits the same restaurant, the menu may be populated to provide an indication that the user noted the menu item as being appealing, but has not yet ordered and/or tasted such menu item. In addition, the user's taste palate profile may be adjusted based upon the flavor profile(s) of the second choice menu item(s). For example, a lesser weighting may be applied to adjust the taste palate profile based upon the flavor profile(s) of the second choice menu item(s), e.g., as compared to menu items actually ordered and/or consumed and positively rated by the user giving post-meal feedback.

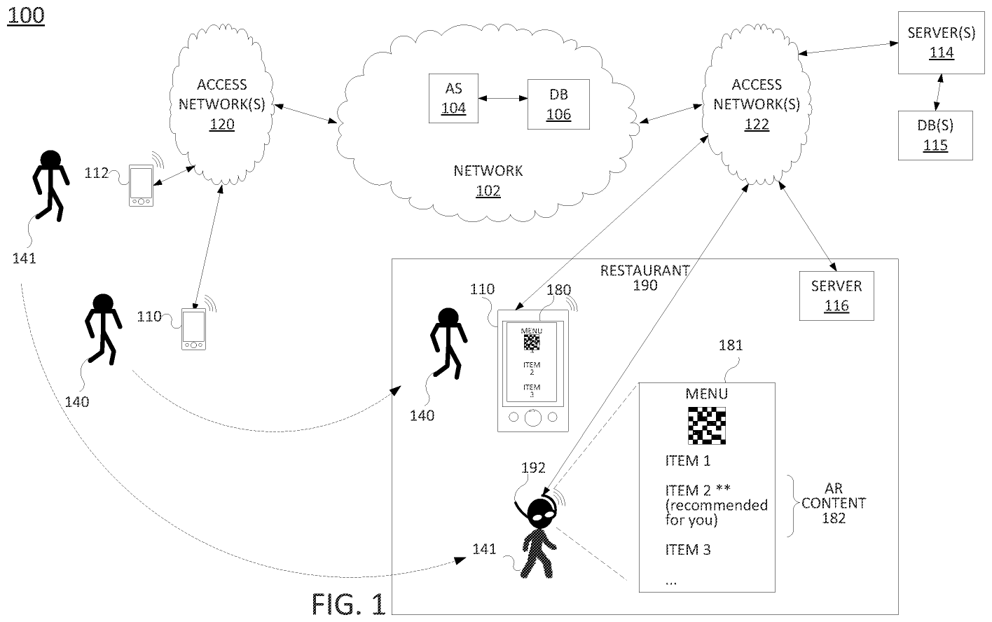

In one example, the present disclosure may enable a user to reserve a meal ahead of time. This may be advantageous in the event that certain ingredients may tend to run out of supply. This may also help the restaurant better manage orders from their sources/suppliers and enable an improved just-in-time supply chain. Also, in this way, the restaurant is enabled to present a future version of the menu that may differ from a present version based on projected future availability of ingredients—allowing for future orders of menu items that include ingredients coming in a current shipment. Examples of the present disclosure therefore enable restaurant menus to be more informative and useful to a diner when making choices. In addition the menus are more effective to a restaurant owner as well by enabling their most efficient communication with the diner, incorporating data about the diner and supplies on hand, en route, or on order. The diner is able to understand more information about menu offerings and better predict whether the diner will like the choices made when dining. In addition, a restaurant may better dynamically managing menus and inventories of ingredients, particularly for perishable items and increase the likelihood that the diner will be pleased with their menu choices. These and other aspects of the present disclosure are described in greater detail below in connection with the examples of FIGS. 1-5.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G and the like), a long term evolution (LTE) network, and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102 (e.g., a telecommunication network of a telecommunication service provider). The network 102 may be in communication with one or more access networks 120 and 122, and the Internet (not shown). In one example, network 102 may combine core network components of a cellular network with components of a triple play service network; where triple-play services include telephone services, Internet services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a broadcast television network, e.g., a traditional cable provider network or an Internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video-on-demand (VoD) server, and so forth. For ease of illustration, various additional elements of network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an Institute of Electrical and Electronics Engineers (IEEE) 802.11/Wi-Fi network and the like), cellular access networks, 3^{rd} party networks, and the like. For example, the operator of network 102 may provide a broadband Internet access service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental, or educational institution LANs, and the like. In one example, one or more of access network(s) 122 may be associated with a restaurant 190.

In one example, the access networks 120 may be in communication with one or more devices 110 and 112. Similarly, access networks 122 may be in communication with one or more devices, e.g., servers 114 and 116, device 192, etc. Access networks 120 and 122 may transmit and receive communications between devices 110 and 112, servers 114 and 116, device 192, application server (AS) 104 and/or other components of network 102, devices reachable via the Internet in general, and so forth. In one example, each of the devices 110, 112, and 192 may comprise any single device or combination of devices that may comprise an endpoint device, e.g., a client device. For example, the devices 110, 112, and 192 may each comprise a mobile device, a cellular smart phone, a laptop, a tablet computer, a desktop computer, a wearable computing device, an application server, a bank or cluster of such devices, an IoT device, and the like. In one particular example, device 192 may comprise a wearable computing device, e.g., “smart eyeglasses,” and may include augmented reality (AR) projection capabilities as discussed below.

In one example, device 110 may be associated with a user 140 and devices 112 and 192 may be associated with another user 141, e.g., diners/patrons making reservations to eat at a restaurant 190. For instance, device 110 and/or device 112 may have an application (app) installed thereon, which may facilitate booking/reserving tables at one or more restaurants, including restaurant 190. In one example, devices 110, 112, and 192 may store diner profiles of the respective users 140 and 141, as described herein. In one example, any one or more of devices 110, 112, or 192 may include one or more radio frequency (RF) transceivers (as well as antenna(s), and/or other components) for cellular communications and/or for non-cellular wireless communications, such as for IEEE 802.11 based communications, IEEE 802.15 based communications, and so forth.

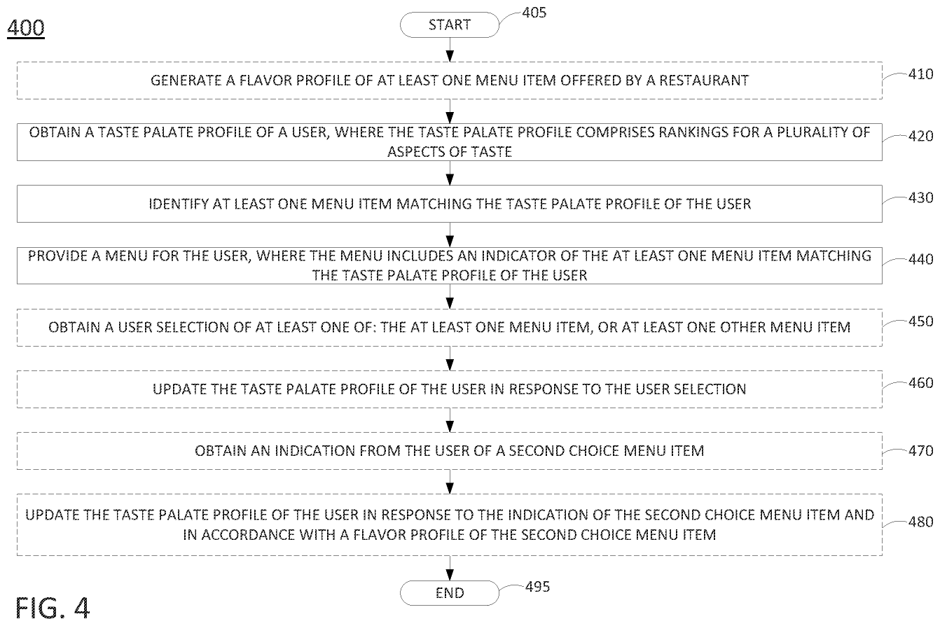

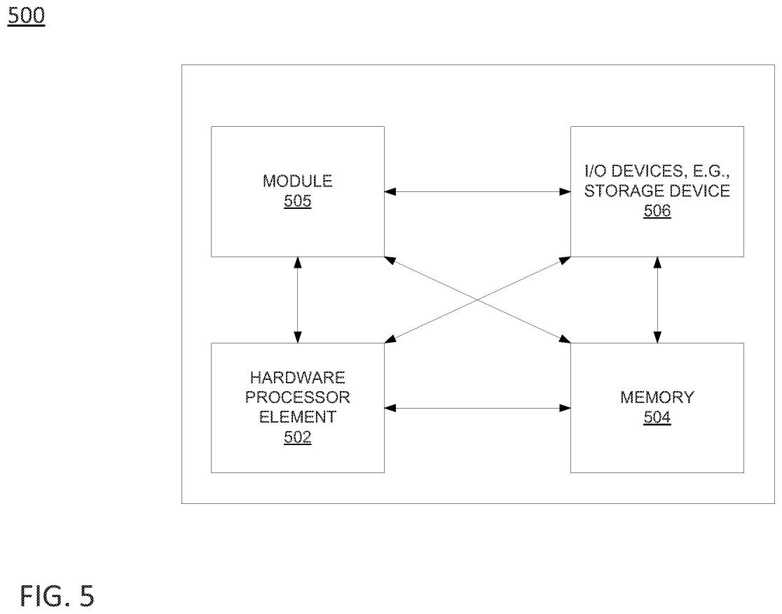

In one example, any one or more of devices 110, 112, or 192 may comprise a computing device or processing system, such as computing system 500 depicted in FIG. 5, and may be configured to provide one or more operations or functions in connection with examples of the present disclosure for providing a menu for a user including an indicator of at least one menu item matching a taste palate profile of the user. A flowchart of an example method 400 for providing a menu for a user including an indicator of at least one menu item matching a taste palate profile of the user is illustrated in FIG. 4 and discussed in greater detail below.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 5 and discussed below) or multiple computing devices collectively configured to perform various steps, functions, and/or operations in accordance with the present disclosure.

Similarly, server(s) 114 may each comprise a computing system or server, such as computing system 500 depicted in FIG. 5, and may be configured to perform operations in connection with examples of the present disclosure for providing a menu for a user including an indicator of at least one menu item matching a taste palate profile of the user, e.g., as described in connection with FIG. 4. For instance, server(s) 114 may provide a diner profile management system in accordance with the present disclosure. In one example, database(s) 115 may represent one or more distributed file systems, e.g., a Hadoop® Distributed File System (HDFS™), or the like. Server(s) 114 may receive and store information in database(s) 115 comprising diner profiles of different diners, such as users 140 and 141, may update the diner profiles, including taste palate profiles, and so forth.

In one example, AS 104 may comprise a network-based server (or servers) providing a diner profile management system. In this regard, AS 104 may comprise the same or similar components as server(s) 114 and may provide the same or similar functions, or at least a portion thereof. For instance, an operator of network 102 may provide a diner profile management service via AS 104 in accordance with the present disclosure (e.g., in addition to telecommunication services such as TV, phone, internet access, etc., as described above). For example, AS 104 may store in DB(s) 106 diner profiles in a diner database. For instance, DB(s) 106 may be the same as or similar to DB(s) 115. Thus, although the following examples are described primarily in connection with server(s) 114, it should be understood that the descriptions may equally apply to AS 104.

As illustrated in FIG. 1, server 116 may comprise a restaurant management system (e.g., a processing system) of restaurant 190. Server 116 may store an inventory of ingredients, available menu items, their costs of ingredients and/or cost to produce, the menu prices, the profit per menu item, etc., reservations for current and upcoming meals, the staff scheduled to work for each meal, and so forth. In addition, in one example, server 116 may obtain and store diner profiles of diners at current or upcoming meals, such as users 140 and 141. In addition, server 116 may comprise a computing system or server, such as computing system 500 depicted in FIG. 5, and may be configured to perform operations in connection with examples of the present disclosure for providing a menu for a user including an indicator of at least one menu item matching a taste palate profile of the user, e.g., as described in connection with FIG. 4.

In an illustrative example, users 140 and 141 may book a dinner reservation with restaurant 190. For instance, either or both of users 140 and 141 may make a reservation via device 110 and/or device 112, such as using an app or navigating to a webpage to connect to a booking and reservation system (e.g., in one example servers 116). In one example, diner profiles of users 140 and 141 be provided to the restaurant 190. For instance, users 140 and 141 may grant permission for server(s) 114 to provide the respective diner profiles to server 116 in connection with the particular reservation, or may provide more general authorizations to enable server(s) 114 to provide the diner profiles to restaurants for which reservations have been made. In another example, diner profiles may be provided to server 116 when devices of users 140 and 141 are present at the restaurant 190 (e.g., devices 110 and 192). For instance, the presence of users 140 and 141 may be detected at restaurant 190 via the devices' respective Global Positioning System (GPS) location data, which may be provided by devices 110 and 192 to server(s) 114, which may then provide the diner profiles to server 116. Alternatively, or in addition, server 116 may detect the presence of devices 110 and 192 via peer-to-peer and/or short range wireless communications, e.g., IEEE 802.11 based communications (e.g., Wi-Fi, Wi-Fi Direct), IEEE 802.15 based communications (e.g., Bluetooth, Bluetooth Low Energy (BLE), and/or ZigBee communications), LTE Direct, Dedicated Short Range Communications (DSRC), e.g., in the 5.9 MHz band, or the like. Accordingly, server 116 may then request the diner profiles from server(s) 114. For instance, server 116 may obtain diner identifiers (e.g., diner IDs) from users 140 and 141, and/or from devices 110 and 192. However, in another example, devices 110 and 192 may alternatively or additionally maintain respective diner profiles locally, and may provide such diner profiles to server 116 directly upon request (e.g., with authorization of the respective users 140 and 141).

As noted above, the diner profiles may include taste palate profiles/preferences of the users 140 and 141. In addition, the server 116 may store flavor profiles of different menu items that may be available, and may determine one or more menu items that match the taste palate profiles of the users 140 and 141. As such, server 116 may generate, or render, personalized menus for each of users 140 and 141, e.g., including indicators of one or more menu items matching the respective taste palate profiles of users 140 and 141. For instance, the restaurant 190 may set a selection of menu items that the restaurant 190 is offering for a particular meal. Thus, a menu template, or “proto-menu” may include all of the menu items that the restaurant 190 is offering to patrons/diners to order during that meal. From this proto-menu, server 116 may then render a menu for user 140, which may include indicators for one or more menu items that match the taste palate profile of user 140, such as highlighting, providing a matching score next to the menu item, providing a text note next to the menu item indicating the match and/or a recommendation of the menu item, etc., based on the taste palate profile of user 140. Similarly, server 116 may render a menu for user 140, which may include indicators for one or more menu items that match the taste palate profile of user 141, such as highlighting, providing a matching score next to the menu item, providing a text note next to the menu item indicating the match and/or a recommendation of the menu item, etc., based on the taste palate profile of user 141. For example, server 116 may generate a matching score for each user 140 and 141 for each menu item, where the matching score indicates a degree to which the taste palate profile of the user matches the flavor profile of the menu item. For instance, server 116 may determine a difference in values for each aspect of taste from the taste palate profile of the user and the flavor profile of the menu item, respectively. The differences for each aspect of taste may then be summed to provide an overall matching score. Thus, for example, a lower score may indicate a greater degree of matching between the taste palate profile of a user and a flavor profile of a menu item, or vice versa using a higher score. For instance, a score of zero (0) may indicate a perfect match or vice versa a score of ten (10) may indicate a perfect match.

In the present example, a first menu 180 may be provided to user 140 at device 110. While in one example, a second menu 181 may be presented to user 141 at device 112, where FIG. 1 illustrates an example where user 141 may have an additional device (device 192 (e.g., smart eyeglasses)) and may be given the second menu 181 in physical form. For instance, restaurant 190 may have a printed menu that is given to user 141. However, the second menu 181 as experienced by user 141 may include AR content 182 that is projected in the appropriate location(s) on the second menu 181. For instance, device 192 may detect a quick response (QR) code, barcode, or the like on the second menu 181, and may thereby obtain AR content 182 and instructions pertaining to where and when to project the AR content 182. For example, “item 2” may be recommended for user 141 based on a matching score with the taste palate profile of user 141. For instance, in one example, server 116 may establish communication with device 192, e.g., when user 141 wearing device 192 enter the restaurant 190, and may provide the AR content 182 to device 192. In another example, device 192 may scan a QR code or the like on the second menu 181, which may cause the device 192 to establish a network-based communication with server(s) 114 and/or server 116. Server(s) 114 and/or server 116 may then determine which menu item(s) match the taste palate profile of user 141 and may generate and provide the AR content 182 to device 192 for presentation to the user 141.

In one example, user 140 may make a selection of one or more menu items, e.g., via interactive components of the first menu 180 that is presented via device 110. Similarly, user 141 may make a selection of one or more menu items in accordance with the second menu 181. For instance, device 192 may detect a gesture or gestures of user 141 which may indicate selection of one or more menu items. For example, user 141 may double tap a part of the second menu 181. The device 192 may then determine a portion of the second menu 181 tapped by user 141 (e.g., using AR spatial detection with reference to one or more spatial markers of the second menu 181 (e.g., at least a QR code, barcode, or the like)). As such, server 116 and/or server(s) 114 may establish an interactive menu using a paper or other physical menus in conjunction with AR capabilities of diners'/patrons' wearable computing devices. Furthermore, in one embodiment, the menus presented to user 140 and 141 are dynamically modified and customized in accordance with their respective taste palate profile.

In any case, the users' selections may be conveyed to server 116, e.g., via peer-to-peer, WLAN, and/or short range wireless communications with server 116, via cellular connections of devices 110 and 192 and communication sessions with server 116 over one or more networks, and/or via server(s) 114 as an intermediary service. For instance, server 116 may provide an ordering and fulfillment system that may record a table's orders, present the orders on one or more display screens in a kitchen of the restaurant 190, keep track of a current bill for the table, and so forth. In addition, selections of menu items by users 140 and 141 may be reported to server(s) 114 (e.g., by devices 110 and 112, and/or by server 116). In one example, the flavor profile(s) of the menu item(s) may also be provided to server(s) 114 (e.g., if not provided in advance to server(s) 114; for instance, some restaurants may provide and regularly share and/or update data regarding menu items, the flavor profiles, allergen information, etc. to a diner profile management system, e.g., provided via server(s) 114). Thus, as noted above, the taste palate profile of user 140 and/or user 141 may be updated accordingly, in response to the menu item(s) that is/are selected.

In one example, users 140 and 141 may also provide ratings/feedback regarding menu items that are ordered, tasted, and/or consumed, e.g., via devices 110 and 192. For instance, an app of device 110 may present a prompt for the user 140 to rate a menu item, e.g., 1 to 100, zero to five stars, etc. The rating of user 140 may then be communicated to server 116 and/or to server(s) 114. In such case, the taste palate profile of user 140 may then be further adjusted. For example, if the user 140 ordered a menu item, server(s) 114 may update the taste palate profile of the user 140 in the direction of the flavor profile of the menu item. However, if the user 140 provides a negative rating/feedback (e.g., less than 50 out of 100, less than 70 out of 100, etc., less than 3 stars out of five, or the like), then the server(s) 114 may refrain from updating the taste palate profile based upon the particular menu item (or may undo a previous update). In one example, user 141 may similarly be prompted to provide feedback, such as via an audio/automated speech prompt, and may provide verbal feedback that may be interpreted by software of device 192 and/or of server(s) 114 to determine the rating of user 141 of a menu item.

It should be noted that the foregoing is just one illustrative example of how methods of the present disclosure for providing a menu for a user including an indicator of at least one menu item matching a taste palate profile of the user may operate. Thus, it should be noted that in other, further, and different examples, aspects described above with respect to server 116 may alternatively or additionally be provided by server(s) 114. For instance, instead of restaurant 190 maintaining a dedicated, on-premises restaurant management system, e.g., server 116, restaurant 190 may subscribe to a network-based and/or cloud-based restaurant management system, e.g., provided by server(s) 114. For instance, server(s) 114 may provide for inventory management, including ordering and supply chain management, may handle booking and reservations, payments and billing, staff scheduling, customer relationship management, and so forth, in addition to providing electronic menus and integrating with diner profile management services of server(s) 114. In other words, server(s) 114 may offer a comprehensive diner profile management system and restaurant management system as a service to various user/diners and various restaurants.

Similarly, in another example, aspects described above with respect to server(s) 114 and/or server 116 may alternatively or additionally be provided via user devices, such as devices 110, 112, and/or 192. For example, diner profiles may be maintained on devices 110 and 112 (and/or device 192). Upon making a reservation with restaurant 190 (or upon entering restaurant 190) server 116 and/or server(s) 114 may provide a menu (e.g., an electronic menu) to the respective devices 110 and 112 (and/or device 192). The electronic menu may include a number of menu items, along with the associated flavor profiles. In addition, in such an example, the respective devices 110 and 112 (and/or device 192) may then present the menu in a personalized way for the users 140 and 141. For instance, device 110 may determine which menu item(s) (e.g., accessing associated QR codes of the menu items) match the taste palate profile of user 140, and may provide one or more indicators on the menu that is presented via a display screen of device 110 for user 140. In one example, the menu may be interactive, such that the user 140 may make selections of menu items and the selections are conveyed to restaurant 190, e.g., to server 116. However, in another example, the user 140 may provide selections to the restaurant 190 conventionally, e.g., by placing an order with wait-staff of the restaurant 190. At the same time, the user 140 may note via device 110 the selection(s) made. Device 110 may then update the taste palate profile of user 140 based upon the flavor profile(s) of the menu item(s) that is/are received as part of the electronic menu. Alternatively, or in addition, device 110 may communicate selections of menu items to server(s) 114, which may update the taste plate profile of user 140. In either case, the taste palate profile of user 140 is not revealed to the restaurant 190, thus providing the same benefits of the present disclosure to the user 140, while maintaining the privacy of the personal information of user 140 (and similarly for user 141 and device 110 and/or device 192).

In yet another example, users 140 and 141 need not utilize personal devices in connection with a meal with restaurant 190. For instance, users 140 and 141 may provide diner IDs to restaurant 190, e.g., either at booking of the reservation or at arrival. Restaurant 190 may then obtain taste palate profiles of users 140 and 141 by transmitting requests to server(s) 114 for the taste palate profiles associated with the respective diner IDs, may personalize menus for users 140 and 141, may record the selections of menu items for users 140 and 141, and may provide the selections and the associated flavor profiles to server(s) 114, which may update and maintain the diner profiles of user 140 and 141 via the associated diner IDs.

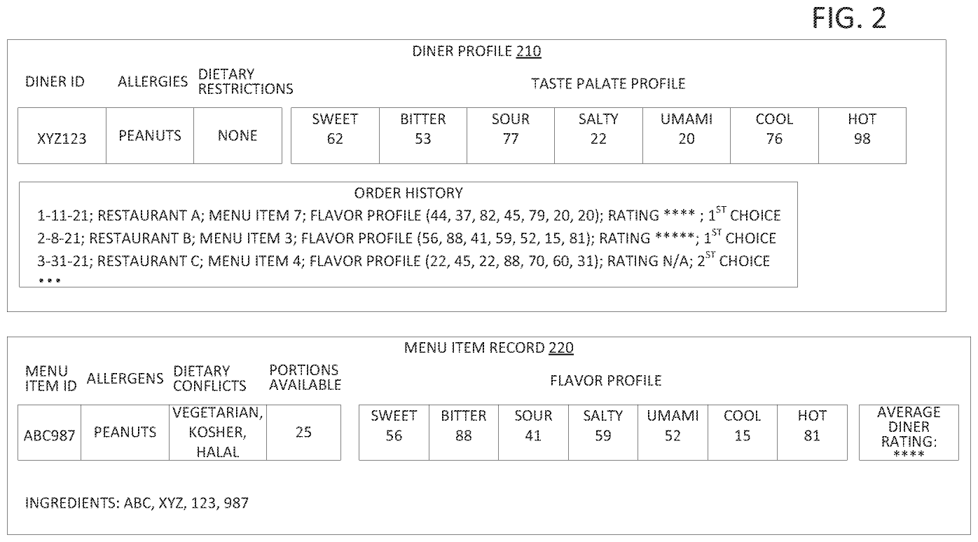

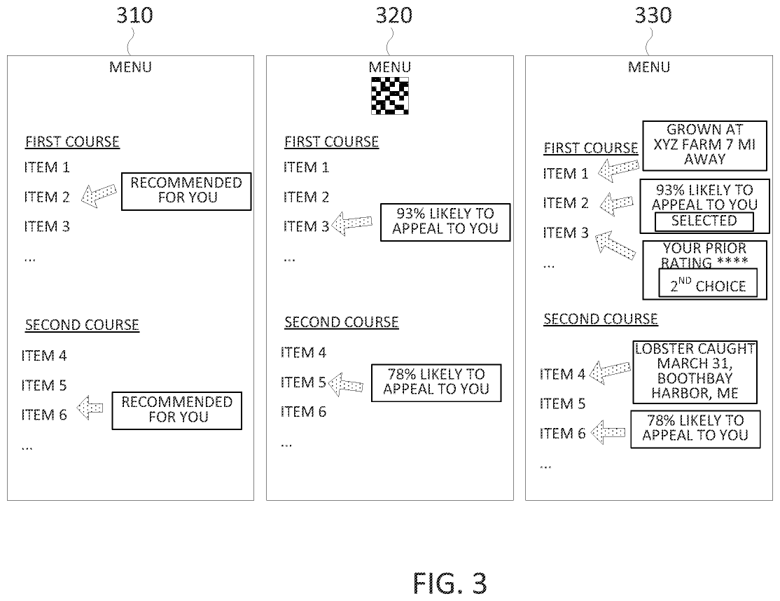

In addition to the foregoing, various other features of the present disclosure may be provided via the system 100. For instance, in one example, server 116 of restaurant 190 may obtain taste palate profiles of a number of diners/patrons having reservations for a same meal at the restaurant 190. Server 116 may then seek menu items from a set of possible menu items that the restaurant 190 is capable of preparing and that are best matched to the greatest number of taste palate profiles of the diners/patrons having reservations for that meal. For instance, if the kitchen is skilled at preparing 30 different main courses, but is only capable of preparing eight (8) different types of main courses at any one meal (e.g., due to the size of the kitchen, the number of kitchen staff, etc.), then the server 116 may seek to find the 8 dishes that best match to the widest number of taste palate profiles of the diners/patrons expected for that meal. In addition, in one example, server 116 may further account for the available ingredients in inventory or expected to be in inventory at the time of the meal, the cost of ingredients per dish and/or the expected revenue per dish, and so forth. For instance, the server 116 may also prioritize dishes/menu items that will maximize revenue, will help to consume items in inventory that may otherwise expire in the next few days, and so forth. In still further examples, restaurant 190 may obtain allergen and/or dietary restrictions of users 140 and 141 from the respective diner profiles, and may provide additional notes on the menu(s) of any conflicting menu items (or conversely, those that are compliant), or may remove items from the menu entirely. In one example, server 116 may apply one or more constraints, such as a head chef setting a maximum numbers of concurrent main courses, first courses, desserts, etc. In addition, further details, such as example taste palate profiles, flavor profiles, and electronic menus, are illustrated in FIGS. 2 and 3.

It should also be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102 and/or access networks 120 and 122 may comprise a content distribution network (CDN) having ingest servers, edge servers, and the like. Similarly, although only two access networks 120 and 122 are shown, in other examples, access networks 120 and/or 122 may each comprise a plurality of different access networks that may interface with network 102 independently or in a chained manner. For example, server 114 and server 116 may reach network 102 via different access networks, devices 110 and 112 may reach network 102 via different access networks, and so forth. Thus, these and other modifications are all contemplated within the scope of the present disclosure.

To further illustrate aspects of the present disclosure, FIG. 2 depicts an example diner profile 210 and an example menu item record 220, in accordance with the present disclosure. As illustrated in FIG. 2, the diner profile 210 may include a number of fields, such as: a diner identifier (ID), an allergy indicator field (e.g., in the present example, the user/diner associated with diner ID XYZ123 may be allergic to peanuts), and a dietary restrictions field (e.g., in the present example, the user/diner associated with diner ID XYZ123 may have no dietary restrictions, however, dietary restrictions could include “vegetarian,” “kosher,” “halal,” “lent observation,” “no meat,” “no fish,” and so forth). The diner profile 210 may also include a taste palate profile (e.g., user preferences regarding aspects of taste). In one example, the taste palate profile may comprise at least five aspects of taste, (e.g., sweet, bitter, sour, salty, umami). In the example of FIG. 2, the taste palate profile of diner profile 210 may include additional aspects of taste, (e.g., cold or hot). It should be noted that “cold” and “hot” do not necessarily correspond to temperatures of dishes/menu items, but may represent taste perceptions commonly referred to as cold or hot. For instance, “cold” may be associate with menthol or minty presentation, while “hot” may be associated with all varieties of spicy presentation (e.g., mild, medium, spicy, very spicy, Thai hot, chili flavors, wasabi flavors, or the like). As illustrated in FIG. 2, the taste palate profile may include a value, e.g., a rating, for each aspect of taste, which in the present example may fall anywhere on a scale from 1 to 100 (or 0 to 100). For instance, a rating of 1 may represent that the user intensely dislikes a particular aspect of taste, while a rating of 100 may represent that the user strongly likes the particular aspect of taste. Thus, for example, the user associated with diner ID XYZ123 of diner profile 210 may have a definitive dislike for salty food (e.g., as evidenced by the relatively low rating of 22 for “salty”).

The diner profile 210 may further include a food order history, which may include sequential entries of different menu items ordered by the user associated with diner ID XYZ123 at various restaurants (or “second choice” menu items). For example, each entry in the food order history may include the date, the restaurant (e.g., a restaurant ID), the menu item (e.g., a menu item ID), the flavor profile for the menu item, the user rating for the menu item (if available), and an indication of whether the menu item is a 1^{st} choice menu item (e.g., actually ordered and/or consumed) or a 2^{nd} choice menu item (that the user indicated was interesting, but that the user did not actually order). It should be noted that the values/ratings of each aspect of taste in the taste palate profile may be generated based upon past food/menu item orders of the user as well as user ratings of different menu items. In one example, the rating for each aspect of taste may comprise an average of metrics for the aspect of taste associated with different menu items ordered by the user. In one example, a time weighting (e.g., a time weighted average, a time weighted moving average, etc.) may be applied to favor more recent food orders and/or food/menu item ratings. For instance, menu items more recently ordered may be counted in higher multiples for purposes of calculating averages (e.g., twice, three times, five times, etc.), while menu items ordered further in the past may be counted in lower multiples, singularly, and eventually may be phased out of the calculations (e.g., when older than a certain time, or when a certain number of more recent menu items are available for use in calculations, and so on).

In one example, a user rating of a food item may impact the calculations of the ratings for each aspect of taste in the taste palate profile. For example, for a five star rating the menu item may be included three times for purposes of calculating the ratings for each aspect of taste in the taste palate profile. For a four star rating, the menu item may be included two times. For a three star rating, the menu item may be included one time. However, in one example, for a two or one star rating, the menu item may be entirely excluded from the calculations of the ratings for each aspect of taste in the taste palate profile. In other examples, a different methodology of the same or a similar nature for calculating of the ratings for each aspect of taste in the taste palate profile may be employed.

For instance, in one example, a user taste palate profile may be generated and/or updated in accordance with a machine learning (ML)/artificial intelligence (AI)-based process. For instance, a user's taste palate profile may be initially set via a neural network or similar predictive algorithm taking inputs of taste palate profiles of a user's family members and predicting a taste palate profile of the user. For example, a neural network may be trained in accordance with a training data set of users having known taste palate profiles and the user's family members (also having known taste palate profiles). The neural network may then learn and encode correlations between taste palate profiles of family members and those of a given users. Similarly, the updating of a user's taste palate profile may also include an ML/AI-based process. For instance, the user's taste palate profile may comprise an output of a recurrent neural network (RNN), long-short term memory (LSTM), or other predictive model that utilizes a user's ordered menu items (an in some cases, second choice items, or the like) to predict the user's taste palate profile, and that may weight different items based upon how recently, or how far in the past, the item was ordered. In one example, a user's manual override/correction of taste palate profile predictions may be used to tune/retrain the predictive model.

In this regard, it should be noted that as referred to herein, a machine learning model (MLM) (or machine learning-based model) may comprise a machine learning algorithm (MLA) that has been “trained” or configured in accordance with input data (e.g., training data) to perform a particular service, e.g., to predict a user's taste palate profile. Thus, in other examples, the present disclosure may incorporate various types of MLAs/models that utilize training data, such as a support vector machine (SVM), e.g., a linear or non-linear binary classifier, a multi-class classifier, a deep learning algorithm/model, such as another type of deep learning neural network or deep neural network (DNN), a generative adversarial network (GAN), a decision tree algorithms/models, such as gradient boosted decision tree (GBDT), a k-nearest neighbor (KNN) clustering algorithm/model, a regression-based model, such as a multivariate multiple regression model, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth.

As further illustrated in FIG. 2, menu item record 220 may include a menu item identifier (ID), allergen information, dietary conflict information, and a number of portion available (e.g., based upon the ingredients available in a restaurant inventory). The menu item record 220 may further include a flavor profile, which may include metrics for each aspect of taste that may be utilized according to an example of the present disclosure (e.g., in the present example of FIG. 2, sweet, bitter, sour, salty, umami, cold, or hot). For instance, the metrics may be similar to the user ratings in the flavor profile for each aspect of taste. However, the metrics may objectively characterize the taste presentation of the menu item (e.g., according to the perception of one or more users providing ratings/scores the menu item or ingredient, such as kitchen staff, other restaurant staff, food critics, etc., or according to one or more automated systems that may detect olfactory components and/or chemical compositions of the food items or ingredients, and which may quantify the menu items or ingredients on the different aspects of taste presenting in the food items or ingredients, etc.). In the present example, the menu item having menu item ID ABC987 may be predominantly bitter and hot (e.g., having metrics of 88 and 81, respectively, for these aspects of taste).

It should be noted that in one example, a restaurant or another entity providing a restaurant management system may similarly maintain ingredient records for ingredients in inventory (or otherwise used by the restaurant), which may include the quantities on hand or on order, the next shipment arrival estimate, etc., and which may further include a flavor profile. Thus, in one example, a flavor profile for a menu item may alternatively or additionally be calculated as a composite of the flavor profiles of the constituent ingredients. In one example, such calculation may be scaled based upon the proportions of such ingredients. In this regard, the example of FIG. 2 further illustrates that menu item record 220 may also include a list of the constituent ingredients for the menu item having menu item ID ABC987. In addition, it should be noted that FIG. 2 illustrates a representative diner profile 210 and menu item record 220, and that in other, further, and different examples, diner profiles and menu item records may have different forms, may include additional fields or different fields, may have ratings and metrics on a different scale, and so forth. Thus, these and other modifications are all contemplated within the scope of the present disclosure.

To further aid in understanding the present disclosure, FIG. 3 illustrates example menus (e.g., electronic menus) 310-330, in accordance with the present disclosure. The first example menu 310 illustrates a list of menu items of a first course of a meal (items 1-3) and a second course of the meal (items 4-6). In accordance with the present disclosure, menu items that match a taste palate profile of a user may also be provided with indicators of such menu items. For instance, in the example menu 310, menu items 2 and 6 may match the user's taste palate profile and may be indicated to the user with highlighting, e.g., side notes and highlight/arrows with the text “recommended for you.” For instance, items 2 and 6 may be determined to “match” the user's taste palate profile based upon determining that each of these menu items is a closest match (e.g., lowest matching score from among available menu items for each respective course of the meal) as discussed above, each of these menu items has a matching score to the user's taste palate profile that exceeds a threshold score (e.g., is lower than or equal to the threshold score), etc.

In a second example, menu 320 is similar to menu 310, but may present recommended/matching menu items in a different manner. For instance, a different user may be experiencing the same meal at the same restaurant, but may have a different taste palate profile that best matches to menu items 3 and 5. In addition, for illustrative purposes, menu 320 depicts that the indicators for these menu items may include numerical, percentage scores indicating a degree to which the user's taste palate profile matches the menu items. In one example, the percentages may not directly correspond to the matching scores, but may be scaled to a percentage score (e.g., an inverse scaling, where a lower matching scores may indicate a better match, while a higher percentage indicates a better match). In addition, the example menu 320 may include a QR code. For instance, menu 320 may comprise a paper or other physical menus that may be scanned by an AR device of a user, wherein the AR device may then present the indicators as an overlay within the field of view (FoV) of the user and/or a FoV of an outward facing camera of the AR device.

In a third example, menu 330 may be the same or similar to menus 310 and 320, but illustrates that additional information may also be conveyed via an electronic, interactive menu of the present disclosure. For instance, menu 330 includes indicators of matching menu items 2 and 6 (e.g., including the percent likelihood of the menu items appealing to the user). Menu 330 further includes additional menu item information, such as menu item 1 being “grown at XYZ farm 7 miles away” and menu item 4 being a “lobster caught March 31, Boothbay Harbor, Me.” Menu 330 additionally includes menu item information including the user's prior rating of menu item 3 based upon a past meal at the restaurant. In addition, menu 330 includes indicators of the menu item ordered by the user (menu item 2), and the user's “second choice” menu item (e.g., menu item 3). For instance, the user may have previously ordered menu item 3 at an earlier meal at the same restaurant, which the user liked and rated highly (e.g., four stars). While the user may like to try a different menu item for the current meal (e.g., menu item 2), the user may also want to note the second choice as menu item 3, such that the user's taste palate profile may continue to be appropriately influenced by the user's satisfaction and preference for menu item 3. It should also be noted that FIG. 3 illustrates just several examples of how visual indicators may be provided for menu items in interactive, electronic menus of the present disclosure. For instance, various other menu presentations may be utilized depending upon the desires of a restaurant to interact with guests solely via their user devices, or conversely, to utilize physical menus, etc. Similarly, different indicators may be used for different AR interfaces, different AR endpoint devices with different components and capabilities, and so on.

FIG. 4 illustrates a flowchart of an example method 400 for providing a menu for a user including an indicator of at least one menu item matching a taste palate profile of the user, in accordance with the present disclosure. In one example, the method 400 is performed by a server of a restaurant, such as server 116 of FIG. 1, or any one or more components thereof, a server or servers of a diner profile management system, such as server(s) 114 or AS 104 of FIG. 1, or any one or more components thereof, or by a user device, such as any of devices 110, 112, or 192 of FIG. 1, or any one or more components thereof, or by any one or more of such servers or devices in conjunction with one another and/or in conjunction with other devices and/or components of system 100 of FIG. 1. In one example, the steps, functions, or operations of method 400 may be performed by a computing device or processing system, such as computing system 500 and/or hardware processor element 502 as described in connection with FIG. 5 below. For instance, the computing system 500 may represent any one or more components of the system 100 that is/are configured to perform the steps, functions and/or operations of the method 400. Similarly, in one example, the steps, functions, or operations of the method 400 may be performed by a processing system comprising one or more computing devices collectively configured to perform various steps, functions, and/or operations of the method 400. For instance, multiple instances of the computing system 500 may collectively function as a processing system. For illustrative purposes, the method 400 is described in greater detail below in connection with an example performed by a processing system. The method 400 begins in step 405 and may proceed to optional step 410 or to step 420.

At optional step 410, the processing system may generate a flavor profile for at least one menu item of a restaurant. For instance, the processing system may comprise a processing system associated with the restaurant offering the at least one menu item, or a processing system of a network-based service (e.g., having access to the menu items, ingredients, quantities, etc. of the restaurant). It should be noted that in another example, the method 400 may be performed by a processing system of a user device. However, in such example, optional step 410 may be omitted. In one example, the flavor profile may comprise metrics for the at least five aspects of taste associated with the at least one menu item. In accordance with the present disclosure, the at least five aspects of taste may comprise: sweet, salty, sour, bitter, and umami. In one example, the at least five aspects of taste may further comprise at least one of: hot, cold, or astringency. In one example, the flavor profile is generated from flavor profiles of a plurality of ingredients of the at least one menu item. Alternatively, or in addition, the metrics of the flavor profile may objectively characterize the taste presentation of the menu item (e.g., according to the perception of one or more users providing ratings/scores the menu item or ingredients thereof, or according to one or more automated systems that may detect olfactory components and/or chemical compositions of the menu items or ingredients, and which may quantify the menu items or ingredients on the different aspects of taste). In one example, the flavor profile may be the same or similar to the example flavor profile of menu item record 220 of FIG. 2.

At step 420, the processing system obtains a taste palate profile of a user, where the taste palate profile of the user comprises rankings for a plurality of aspects of taste e.g., at least two of the five aspects of taste. For instance, as discussed above, rankings may be provided by the user, learned over time, or may start with user rankings and may learn over time, where user may also correct/override any rankings that are automatically learned from menu item ordering events of the user. In accordance with the present disclosure, the at least five aspects of taste may comprise: sweet, salty, sour, bitter, and umami. In one example, the at least five aspects of taste may further comprise at least one of: hot, cold, or astringency. In one example, the taste palate profile of the user may further comprise dietary restrictions of the user. Alternatively, or in addition, the taste palate profile of the user may further comprise preparation preferences of the user for one or more types of menu items, such as burger or steak doneness preferences (e.g., rare, medium rare, medium, medium well, or well done), tuna doneness preferences (e.g., raw, blackened or charred, medium, or well done), pasta doneness preferences (e.g., andante or non-andante), bread crispiness preferences (e.g., soft or crusty), salad dressing saturation preferences (e.g., lightly, regular, saturated, or on the side), etc. In one example, the taste palate profile may be the same or similar to the example taste palate profile of diner profile 210 of FIG. 2. In an example where the method 400 is performed by a processing system of the restaurant, step 420 may comprise obtaining the taste palate profile from a device of the user and/or from a network-based entity, e.g., a diner profile management system such as described above. In an example where the method 400 is performed by a processing system of a network-based service or the user's device, step 420 may comprise retrieving the taste palate profile from an on-device storage or from a network database (e.g., in a diner profile/record).

At step 430, the processing system identifies at least one menu item matching the taste palate profile of the user. For instance, in one example, menu items may be deemed to match or not match the user's taste palate profile depending upon whether a matching score exceeds a threshold (e.g., is lower than a threshold). In another example, matched menu items may be presented as the top menu item or the top several menu items having the best matching scores (e.g., in one example the lowest score, or scores), thereby resulting in a customized menu for a particular user. In one example, the matching score(s) may be calculated by first determining a difference in values for each aspect of taste from the taste palate profile of the user and the flavor profile of the menu item, respectively. The differences for each aspect of taste may then be summed to provide an overall matching score. Thus, in such an example, a lower score indicates a greater degree of matching between the taste palate profile of a user and a flavor profile of a menu item. In one example, step 430 may be performed in response to detecting that the user is physically present at a restaurant, i.e., a preprocessing step in preparing to offer the at least one menu item to the user when user is ready to order an item from a menu.

At step 440, the processing system provides a menu for the user, where the menu includes an indicator of the at least one menu item matching the taste palate profile of the user. For instance, the menu that is provided may selectively identify the menu item(s) matching the taste palate profile of the user. In one example, the indicator may comprise highlighting, additional text recommending the menu item or indicating that the menu item is the top match, or has the best matching score to the user's taste palate profile. In one example, the identifier may comprise the matching score(s) for the at least one menu item, or percentage(s) derived from the matching score(s) quantifying how likely each of the at least one menu item will appeal to the user. In one example, the menu may further include matching scores for other menu items and/or all of the menu items (or percentages derived from respective matching scores). In one example, the indicator may be that the menu item is included on the menu (where other menu items that are available and that do not match the user's taste palate profile may be specifically excluded), thereby resulting in a customized menu for the user.

In one example, step 440 may comprise generating the menu, e.g., from a menu template, or proto-menu. In one example, the menu may comprise an electronic menu that may be transmitted by the processing system to a device of the user. In one example, the menu may comprise an interactive menu that may enable ordering of menu items, may provide additional information (e.g., if a menu item is clicked or otherwise selected for obtaining more information), and so forth. In this regard, it should be noted that in one example, the menu may be generated/rendered to include indicators of one or more menu items that conflict with any dietary restriction(s) of the user.

As noted above, in one example, the method 400 may be performed by a processing system of a user device. In such an example, steps 430 and 440 may comprise the processing system receiving the menu (e.g., an electronic menu, or “proto-menu”) in a well-defined format, such as Extensible Markup Language (XML), Java Script Object Notation (JSON), or the like, and that includes menu item flavor profiles, and then analyzing, generating matching scores, and providing a final display version of the menu personalized to the user. In still another example in which the method 400 is performed by a network-based processing system (e.g., a third-party service), steps 430 and 440 may include obtaining an electronic menu or proto-menu from the restaurant in a well-defined format, where the network-based processing system may maintain the user's taste palate profile, may match menu items to the user's taste palate profile, may generate a final display version of the menu from the proto-menu, and may provide the menu to the user's device for display. In still another example, as described above, the menu may comprise a printed menu or other physical menus, where the indicator may be provided by or via a device of the user (e.g., an AR endpoint device) as an overlay of visual information onto the menu and/or via one or more audible indicators, e.g., a speech synthesizer via a speaker or an earbud announcing “items 3 and 5 on the menu have good flavor profiles matching your taste preference” and the like.

At optional step 450, the processing system may obtain a user selection of at least one of: the at least one menu item, or at least one other menu item. For instance, the menu may be an interactive menu that may enable ordering of menu items, may provide additional information (e.g., if a menu item is clicked or otherwise selected for obtaining more information), and so forth.

At optional step 460, the processing system may update the taste palate profile of the user in response to the user selection. For instance, in one example, the taste palate profile of the user may be updated in response to the user selection in accordance with a flavor profile of the at least one menu item or the at least one other menu item that is selected by the user. For example, as noted above, the rating for each aspect of taste may comprise an average of metrics for the aspect of taste associated with different menu items ordered by the user. Thus, in one example, the taste palate profile may be recalculated according to each new order (where the ordered menu item(s) is/are added to the set of menu items used to calculate the ratings for the aspects of taste). As also noted above, in one example, a time weighting may be applied to favor more recent food orders and/or food/menu item ratings. Thus, for example, the user selection that may be obtained at optional step 450 may be weighted more heavily than user selections from meals many months in the past. It should be noted that in another example, the user selection may be notified to another entity, wherein the taste palate profile of the user is updated in response to the user selection. In other words, in one example, the method 400 may be performed by a processing system that does not maintain diner profiles/taste palate profiles (such as a processing system of a restaurant).

At optional step 470, the processing system may obtain an indication from the user of a second choice menu item. For instance, as noted above, the menu may comprise an interactive menu that may further enable the user to indicate second choice menu item(s) which are not ordered, but which the user indicates are interesting or appealing to the user. In other words, the user may not order the item at this time, but nevertheless has expressed an interest in the item. This additional information can be captured and utilized by the processing system to help the user in the next dining experience.

At optional step 480, the processing system may update the taste palate profile of the user, e.g., in response to the indication obtained at optional step 470 and in accordance with a flavor profile of the second choice menu item. For instance, optional step 480 may be similar to optional step 460, only with respect to the second choice menu item that is not actually ordered for a particular meal. It should be noted that in another example, the second choice menu item may be notified to another entity, wherein the taste palate profile of the user may be updated in response to the second choice menu item. In other words, in one example, the method 400 may be performed by a processing system that does not maintain diner profiles/taste palate profiles (such as a processing system of a restaurant).

Following step 440, or any of the optional steps 450-480, the method 400 proceeds to step 495. At step 495 the method 400 ends.

It should be noted that the method 400 may be expanded to include additional steps, or may be modified to replace steps with different steps, to combine steps, to omit steps, to perform steps in a different order, and so forth. For instance, in one example the processing system may repeat one or more steps of the method 400, such as steps 420-440, steps 420-480, etc. for different meals of the same user, for different users, and so on. In one example, the method 400 may be expanded to include obtaining user feedback, e.g., a score or rating, of the at least one menu item. In addition, in one example, the method 400 may be expanded to include updating the user's taste palate preferences in accordance with such feedback. In one example, the method 400 may be modified to comprise a processing system of a user device detecting that the user is present in a restaurant, providing the taste palate profile to the restaurant, obtaining a personalized menu in response, obtaining a user selection of one or more menu items, updating the taste palate profile of user in response thereto, and so forth. In addition, such an example may alternatively or additionally be network processing system-assisted and/or network processing system-based.

In one example, step 420 may comprise obtaining taste palate profiles of a plurality of users including the user. In addition, in such an example, step 430 may further comprise identifying that the at least one menu item matches the taste palate profiles of a least a portion of the plurality of users. For instance, the best match menu item(s) (e.g., the lowest scores) across all users (e.g., diners/patrons) for that meal or that day may be selected for offering that day and/or that meal and included in the menu at step 440. For example, the consensus of a plurality of diners currently dining in the restaurant or who have ordered the item today can be leveraged to assist a user who is in the process of ordering, e.g., 60% of diners today have ordered item 8 on the menu, or 90% of the diners who ordered item 8 today has rated item 8 with five stars, and so on. For instance, menu items may be selected to include in a proto-menu that may be used as a template for final menus that are personalized to each user, and which may be used to inform the restaurant's staff as to which menu items it should expect to prepare. In one example, the method 400 may additionally identify menu items based on available ingredients, ingredients soon expiring, cost of ingredients, profit per menu item, etc. Thus, these and other modifications are all contemplated within the scope of the present disclosure.

In addition, although not expressly specified above, one or more steps of the method 400 may include a storing, displaying and/or outputting step as required for a particular application. In other words, any data, records, fields, and/or intermediate results discussed in the respective methods can be stored, displayed and/or outputted to another device as required for a particular application. Furthermore, operations, steps, or blocks in FIG. 4 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 5 depicts a high-level block diagram of a computing system 500 (e.g., a computing device or processing system) specifically programmed to perform the functions described herein. For example, any one or more components or devices illustrated in FIG. 1, or described in connection with FIGS. 2-4, may be implemented as the computing system 500. As depicted in FIG. 5, the computing system 500 comprises a hardware processor element 502 (e.g., comprising one or more hardware processors, which may include one or more microprocessor(s), one or more central processing units (CPUs), and/or the like, where the hardware processor element 502 may also represent one example of a “processing system” as referred to herein), a memory 504, (e.g., random access memory (RAM), read only memory (ROM), a disk drive, an optical drive, a magnetic drive, and/or a Universal Serial Bus (USB) drive), a module 505 for providing a menu for a user including an indicator of at least one menu item matching a taste palate profile of the user, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 502 is shown, the computing system 500 may employ a plurality of hardware processor elements. Furthermore, although only one computing device is shown in FIG. 5, if the method(s) as discussed above is implemented in a distributed or parallel manner for a particular illustrative example, e.g., the steps of the above method(s) or the entire method(s) are implemented across multiple or parallel computing devices, then the computing system 500 of FIG. 5 may represent each of those multiple or parallel computing devices. Furthermore, one or more hardware processor elements (e.g., hardware processor element 502) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 502 can also be configured or programmed to cause other devices to perform one or more operations as discussed above. In other words, the hardware processor element 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 505 for providing a menu for a user including an indicator of at least one menu item matching a taste palate profile of the user (e.g., a software program comprising computer-executable instructions) can be loaded into memory 504 and executed by hardware processor element 502 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 502) executing the computer-readable instructions relating to the above described method(s) can be perceived as a programmed processor or a specialized processor. As such, the present module 505 for providing a menu for a user including an indicator of at least one menu item matching a taste palate profile of the user (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
obtaining, by a processing system including at least one processor, a taste palate profile of a user, wherein the taste palate profile of the user comprises rankings for a plurality of aspects of taste;
identifying, by the processing system, at least one menu item matching the taste palate profile of the user; and
providing, by the processing system, a menu for the user, wherein the menu includes an indicator of the at least one menu item matching the taste palate profile of the user.

2. The method of claim 1, wherein the plurality of aspects of taste comprises:
sweet;
salty;
sour;
bitter; and
umami.

3. The method of claim 2, wherein the plurality of aspects of taste further comprises:
hot; and
cold.

4. The method of claim 2, wherein the plurality of aspects of taste further comprises:
astringency.

5. The method of claim 1, wherein the identifying the at least one menu item comprises matching the taste palate profile to a flavor profile of the at least one menu item, wherein the flavor profile comprises metrics for the plurality of aspects of taste associated with the at least one menu item.

6. The method of claim 5, wherein the flavor profile is generated from flavor profiles of a plurality of ingredients of the at least one menu item.

7. The method of claim 6, further comprising:
generating the flavor profile of the at least one menu item.

8. The method of claim 1, further comprising:
obtaining a user selection of at least one of:
the at least one menu item; or
at least one other menu item.

9. The method of claim 8, wherein the taste palate profile of the user is updated in response to the user selection.

10. The method of claim 9, wherein the taste palate profile of the user is updated in response to the user selection in accordance with a flavor profile of the at least one menu item or a flavor profile of the at least one other menu item that is selected by the user.

11. The method of claim 8, further comprising:
updating the taste palate profile of the user in response to the user selection.

12. The method of claim 10, further comprising:
obtaining an indication from the user of a second choice menu item, wherein the taste palate profile of the user is further updated in response to the indication in accordance with a flavor profile of the second choice menu item.

13. The method of claim 12, wherein the second choice menu item was not selected by the user to be consumed by the user.

14. The method of claim 1, wherein the processing system comprises:
a processing system of an endpoint device of the user;
a processing system of a network-based service; or
a processing system associated with a restaurant offering the at least one menu item.

15. The method of claim 1, wherein the identifying the at least one menu item is performed in response to detecting that the user is physically present at a restaurant offering the at least one menu item.

16. The method of claim 1, wherein the taste palate profile further comprises a dietary restriction of the user, wherein the menu includes one or more indicators of one or more menu items that conflict with the dietary restriction of the user.

17. The method of claim 1, wherein the obtaining the taste palate profile of a user comprises obtaining taste palate profiles of a plurality of users including the user.

18. The method of claim 17, wherein the identifying at least one menu item matching the taste palate profile of the user comprises identifying that the at least one menu item matches the taste palate profiles of at least a portion of the plurality of users.

19. A non-transitory computer-readable medium storing instructions that, when executed by a processing system including at least one processor, cause the processing system to perform operations, the operations comprising:
obtaining a taste palate profile of a user, wherein the taste palate profile of the user comprises rankings for a plurality of aspects of taste;
identifying at least one menu item matching the taste palate profile of the user; and
providing a menu for the user, wherein the menu includes an indicator of the at least one menu item matching the taste palate profile of the user.

20. An apparatus comprising:
a processing system including at least one processor; and
a computer-readable medium storing instruction that, when executed by the processing system, cause the processing system to perform operations, the operations comprising:
obtaining a taste palate profile of a user, wherein the taste palate profile of the user comprises rankings for a plurality of aspects of taste;
identifying at least one menu item matching the taste palate profile of the user; and
providing a menu for the user, wherein the menu includes an indicator of the at least one menu item matching the taste palate profile of the user.
